(19) United States
(12) Patent Application Publication
(10) Pub. No.: US 2025/0023641 A1
(43) Pub. Date: Jan. 16, 2025

(54) Electro-optical device with increased extinction ratio

(71) Applicant: HUAWEI TECHNOLOGIES CO., LTD., Shenzhen (CN)

(72) Inventors: Romain Brenot, Munich (DE); Ivan Nicolas Cano Valadez, Munich (DE)

(21) Appl. No.: 18/902,658

(22) Filed: Sep. 30, 2024

Related U.S. Application Data
(63) Continuation of application No. PCT/EP2022/058600, filed on Mar. 31, 2022.

(51) Int. Cl. H04B 10/27

(52) U.S. Cl. CPC H04B 10/27

(57) ABSTRACT

An electro-optical device is provided. The device comprises an optical signal source, which is configured to generate a modulated optical signal having a first extinction ratio. The device further comprises an absorber configured to receive the modulated signal and generate an optical output signal from the modulated signal, wherein the output optical signal has a second extinction ratio, which is larger than the first extinction ratio.

### CROSS-REFERENCE TO RELATED APPLICATIONS

This application is a continuation of International Application No. PCT/EP2022/058600, filed on Mar. 31, 2022, the disclosure of which is hereby incorporated by reference in its entirety.

### TECHNICAL FIELD

The present application relates to electro-optical devices, for example electro-optical devices for generating modulated optical signals.

### BACKGROUND

An important parameter related to the quality of a modulated optical signal is the extinction ratio, ER. In modulated signals with two levels, namely level “1” and level “0”, ER is defined as the ratio between the average power of the “1” level and the average power of the “O” level. A larger ER means that the levels are more separated and can be distinguished more easily on a receiver side. The ER has a significant impact on the overall quality, since it can improve the receiver sensitivity. For these reasons, telecommunication standards often require a minimum ER.

For most electrical-to-optical converters, the ER of the optical signal has a direct relation to the amplitude of the electrical signal, which modulates the light. Hence, by increasing a peak-to-peak voltage of the modulating electrical signal through electrical amplification, the optical signal ER also increases. However, for amplifying the electrical signals, the electrical drivers consume more power, which results in major heating and lower working life.

In the case of directly modulated lasers, DMLs, and direct modulation of vertical-cavity surface-emitting lasers, VCSELs, the ER can also be increased by reducing the bias current. In this way, the “0” level becomes lower, and, as a result, the power ratio of the two levels increases. Even if such means do not require to amplify the electrical signal, a reduction of the optical output power is always the case. Therefore, the achievable distance of the transmission is reduced. Furthermore, by reducing the bias, the transient chirp inherent to direct modulation increases. This side effect can cause distortions on the optical signal reducing its quality and limiting even more the transmission distance. As a result, the possibility to increase the ER by reducing the bias current is very limited.

### SUMMARY

In view of the above, the present application provides an electro-optical device, which achieves a high ER, without incurring certain negative side effects.

According to a first aspect, an electro-optical device is provided. The device comprises an optical signal source, which is configured to generate a modulated optical signal having a first extinction ratio. The device moreover comprises an absorber, which is configured to receive the modulated signal and to generate an output signal from the modulated signal, wherein the output optical signal has a second extinction ratio, which is larger than the first extinction ratio. By these means, a high extinction ratio is reached, while at the same time not incurring any other negative side effects.

According to an implementation, the absorber is configured to generate the output signal from the modulated optical signal, by partially absorbing the modulated optical signal. A very simple construction is thereby achieved.

According to an implementation, the absorber is configured to partially absorb the modulated optical signal with an absorption characteristic dependent on a present signal level of the modulated optical signal. Thus, a significantly high increase in ER is thereby achieved.

Alternatively, the absorber is configured to partially absorb the modulated optical signal with an absorption characteristic. The absorption characteristic therein defines an absorption factor, which is indirectly proportional to a present signal level of the modulated optical signal. Thereby, an significantly high increase in ER is achieved.

According to an implementation, the absorber is a semi-conductor absorber, for example an electro-absorption modulator or a PIN photodiode. A simple construction is thereby achieved.

According to an implementation, the absorber is configured so that the modulated signal induces carriers in the semi-conductor absorber, and the carrier inducing is dependent on a present signal level of the modulated optical signal. A simple construction and high ER increase is thereby achieved.

According to an implementation, the modulated optical signal comprises at least a first signal level and a second signal level. The first signal level is lower than the second signal level. The absorber is configured so that, at the second signal level, carrier inducing in the semi-conductor reaches saturation, resulting in a weaker absorption of the modulated signal at the second signal level than at the first signal level. A simple construction is thereby achieved.

According to an implementation, the absorber is only supplied with the modulated optical signal and a power supply signal. The power supply signal is a constant signal and/or has a frequency, which is at least by a factor of 10 smaller than a frequency of the modulated optical signal. A simple construction is thereby achieved.

According to an implementation, the absorption characteristic is dependent from the power supply signal. The absorber is configured so that the absorption characteristic is controlled by adapting the power supply signal. A very simple control can thereby be achieved.

According to an implementation, the electro-optical device further comprises and absorption controller, configured to control the absorption characteristic of the absorber by controlling the power supply signal provided to the absorber. A high degree of adaptability to different circumstances is thereby achieved.

According to an implementation, the absorption controller is configured to control the absorption characteristic of the absorber in dependency of present transmission conditions of a transmission using the output optical signal or a signal derived therefrom, and/or a present bit error rate of a transmission using the output optical signal or a signal derived therefrom, and/or an external signal, and/or a required output optical power, and/or a constellation shape, and/or an eye diagram shape. A high degree of adaptability of the device to different circumstances is thereby achieved.

According to an implementation, the electro-optical device further comprises an amplifier, which is configured to receive the output optical signal from the absorber and amplify the output optical signal resulting in an amplified output optical signal. An increase in output power, and therefore range is thereby achieved.

According to an implementation, the amplifier is configured to be supplied with power at least in part by the absorber. The overall necessary power is thereby significantly reduced.

According to an implementation, the optical signal source is a direct modulated laser or a vertical-cavity surface-emitting laser, or an electro-absorption modulated laser. A high degree of construction flexibility is thereby achieved.

According to a second aspect, a transmitter is provided, which comprises an electro-optical device, as described before. A high transmission quality can be achieved using this transmitter.

### BRIEF DESCRIPTION OF DRAWINGS

In the following, embodiments are described in more detail with reference to the attached figures and drawings, in which:

FIG. 1 shows a first embodiment of the inventive electro-optical device in a block diagram;

FIG. 2 shows a second embodiment of the inventive electro-optical device in a block diagram;

FIG. 3 shows a third embodiment of the inventive electro-optical device in a block diagram;

FIG. 4 shows a fourth embodiment of the inventive electro-optical device in a block diagram;

FIG. 5 shows a fifth embodiment of the inventive electro-optical device in a block diagram, and

FIG. 6 shows different exemplary signal levels in a sixth embodiment of the inventive electro-optical device.

In the following identical reference signs refer to identical or at least functionally equivalent features if not explicitly specified otherwise.

### DESCRIPTION OF EMBODIMENTS

In the following description, reference is made to the accompanying figures, which form part of the disclosure, and which show, by way of illustration, specific aspects of embodiments or specific aspects in which embodiments may be used. It is understood that embodiments may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

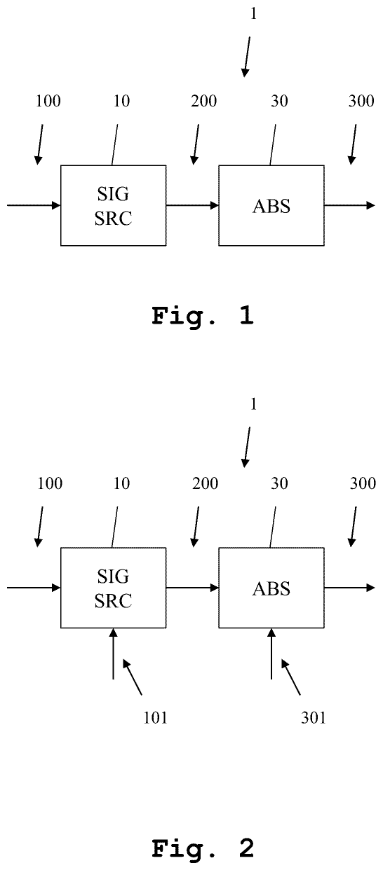

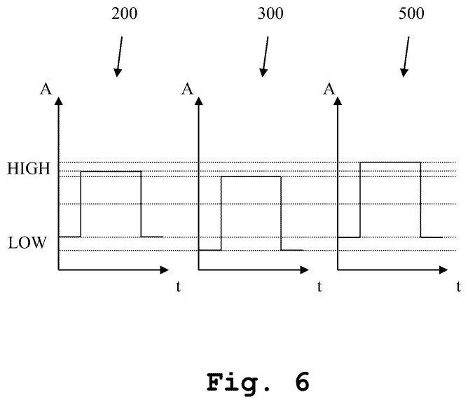

First, the general construction and function of an embodiment of the electro-optical device is described in FIG. 1. With regard to FIG. 2 to FIG. 5, further developments are shown in detail. Finally, in FIG. 6, further explanations regarding the functionality of an embodiment of the electro-optical device is given. Similar entities and reference numbers in different figures have been partially omitted.

In FIG. 1, a first embodiment of the electro-optical device 1 is shown. The electro-optical device 1 comprises a signal source 10 connected to an absorber 30. The signal source 10 is provided with an input signal 100, which is a modulated electrical signal. The signal source 10 generates a modulated optical signal 200 from the input signal 100. The modulated optical signal 200 has a first extinction ratio. The modulated optical signal 200 is provided to the absorber 30. The absorber 30 receives the modulated optical signal 200, and generates and output optical signal 300 from the modulated optical signal 200. The output optical signal 300 has a second extinction ratio, which is larger than the first extinction ratio.

The absorber 30 generates the output optical signal 300 by partially absorbing the modulated optical signal 200. This absorption can be performed dependent on a present signal level of the modulated optical signal 200. This results in higher signal levels being absorbed less than lower signal levels. This significantly increases the ER.

For example, the absorber 30 absorbs with an absorption characteristic, defining an absorption factor. This absorption factor therein is indirectly proportional to a present signal level of the modulated optical signal 200.

The absorber 30 can be a semi-conductor absorber, for example an electro-absorption modulator or a PIN photodiode.

The modulated optical signal 200 therein preferably induces carriers in the semi-conductor absorber, and the carrier inducing therein is dependent of the present signal level of the modulated optical signal 200.

The absorber 30 is configured so that at the second signal level of the modulated optical signal, the higher of the signal levels, the carrier inducing in the semi-conductor absorber reaches saturation, resulting in a weaker absorption of the modulated optical signal 200 at the higher signal level than at the lower signal level.

For example, the absorber 30 is a negatively biased PIN photodiode in which the bandgap of the intrinsic material is close to the wavelength of operation. The electrical bias to the photodiode is applied in a continuous mode, i.e. direct current, DC. The electrical bias determines the strength of the absorption for the absorber 30. The PIN photodiode is placed after the generation of the optical modulated signal and can be integrated. Therefore, the signal source 10 and the absorber 30 may be fabricated jointly. For example, the electro-absorption modulator of the electro-absorption laser can be fabricated together with the absorber. In this case, a very simple construction can be achieved. It is possible to power the electro-absorption modulator in part by the absorber, thereby reusing the absorbed optical power.

For example, an initial extinction ratio of the signal source 10 of 4 dB can be achieved. A resulting second ER achieved by the absorber 30 may be enlarged to, for example, 12 dB.

In FIG. 2, a more detailed second embodiment of the inventive electro-optical device 1 is shown. Here, additionally, power supply signals 101 and 301, provided to the signal source 10 and the absorber 30 are shown. It is important to note that the signal source 10 is provided with a DC power supply signal 101, and the absorber 30 is also provided with a DC power supply signal 301. No other power supply signals are provided in this embodiment. In comparison to an electro-absorption modulator, which is provided with a modulation signal, here, only a DC power supply signal is provided to the absorber 30.

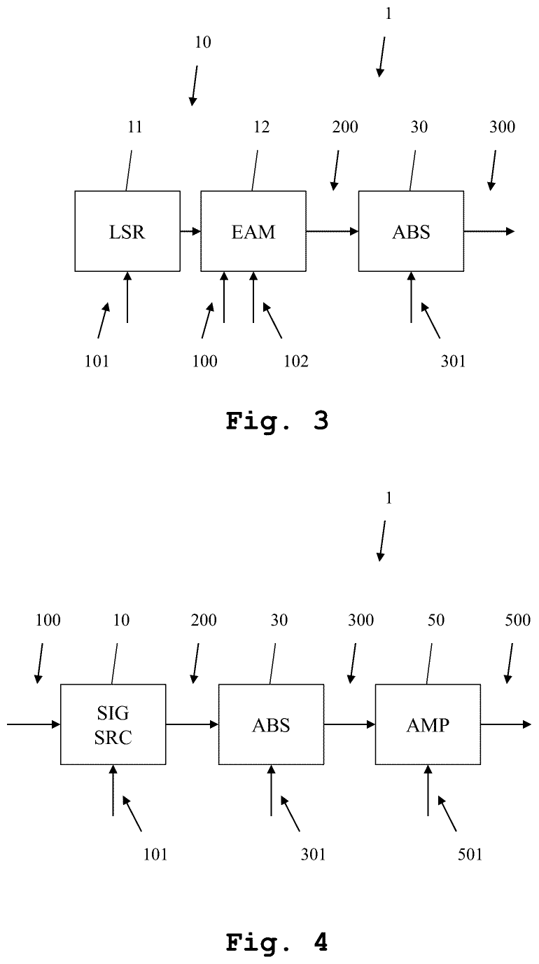

In FIG. 3, a further more detailed embodiment of the inventive electro-optical device 1 is shown. Here, a possible construction of the signal source 10 is shown. In this embodiment, the signal source 10 consists of a laser 11 connected to an electro-absorption modulator 12. Therein, the laser 11 is provided with a DC power supply signal 101 and generates a continuous laser signal, which is not modulated, and which is provided to the electro-absorption modulator 12. The electro-absorption modulator 12 is provided with the input signal 100 and a DC power supply signal 102. The electro-absorption modulator 12 modulates the continuous laser signal provided by the laser 11, resulting in the modulated optical signal 200. Instead of the use of an electro-absorption modulated laser, also a direct modulated laser, or a VCSEL laser is possible.

A further development is shown in FIG. 4. In FIG. 4, the electro-optical device 1 additionally comprises an amplifier 50, which is connected to the output of the amplifier 30. The amplifier 50 receives the output optical signal and amplifies it, resulting in an amplified output optical signal 500. The amplifier 50 therein is only provided with a DC power supply signal 501. A higher output power, at the same extinction ratio can thereby be achieved.

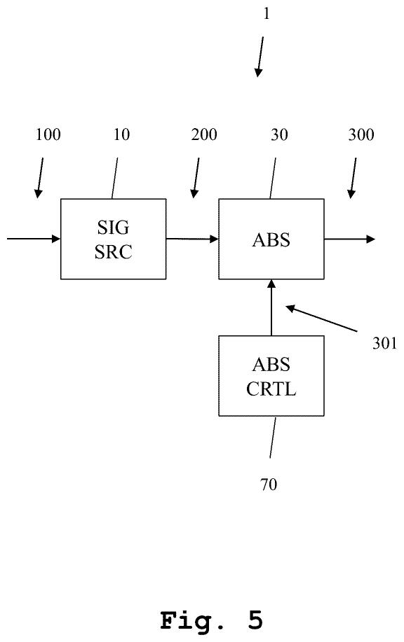

Finally, in FIG. 5, a further even more detailed embodiment of the inventive electro-optical device 1 is shown. Here, the electro-optical device 1 additionally comprises an absorption controller 70, which is connected to the absorber 30. The absorption controller 70 provides the absorber 30 with the DC power supply signal 301. The absorption controller 70 therein controls the level of the DC power supply signal 301. This control may regulate the function of the absorber in dependency of different circumstances. For example, present transmission conditions of a transmission using the optical signal or a signal derived therefrom, and/or a present bit error rate of a transmission using the output optical signal or a signal derived therefrom, and/or an external signal and/or a required output optical power and/or a constellation shape, and/or an eye diagram shape can be performed.

In FIG. 6, different signals in an embodiment of the inventive electro-optical device 1 are shown. On the left, the modulated optical signal 200 is shown. In the middle, the output optical signal 300 is shown while on the right, the amplified output optical signal 500 is shown.

It is readily visible that the signals each have a LOW signal level and a HIGH signal level. By performing the absorption, both the LOW signal level and the HIGH signal level are lowered in the output optical signal 300 in comparison to the modulated optical signal 200. It is important to note, though, that the amount of the lowering of the respective signal levels differs for the HIGH signal level and the LOW signal level. The LOW signal level is significantly stronger lowered than the HIGH signal level. This results in the increase of the extinction ratio.

Moreover, it is readily visible that in the amplified output optical signal 500, both, the LOW signal level as well as the HIGH signal level are significantly increased in comparison to the output optical signal 300. This increase does not significantly affect the extinction ratio, but increases the output power, and thereby the achievable range.

The electro-optical device 1 can be used in a plurality of different application scenarios, in transmitters. For example, a use in optical access networks or intra-datacenter communications is viable. In optical access networks, the cost of the transceiver is a very sensitive limitation. For this reason, simple devices are highly preferred. However, such devices also need to have enough quality to reach the requirement of a minimum ER of, for example, 8 dB and, for example, 6 dB for XG-PON and HSP-PON, respectively. In addition, a minimum optical output power is expected in order to comply with losses of the network. The use of the inventive solution allows the operation with a low voltage power supply signal and only requires a low amount of overall power for achieving high ranges. In intra-datacenter communications intensity modulated signals, e.g. NRZ or PAM-N are used. In these types of networks, high speeds, >50 GBaud are necessary. Also, in these applications cost and footprint are very sensitive. The distance reached is limited to a number of kilometers. The signal quality is still very important to guarantee the link.

It is important to note that the present disclosure is not limited to signals employing only two signal levels. Also signals with more than two signal levels can be processed. In signals with more than two signal levels, the absorption is dependent upon the amplitude of the respective signal level. The higher the amplitude, the lower the additional absorption. For example, a linear indirect relationship between absorption and signal level is possible. The signal can have 2, 3, 4, 5, 6, 7, 8, 9, 10, at least 10, at least 20, at least 30, at least 40, at least 50, or at least 60 signal levels. A high transmission rate can thereby be achieved. The characteristics of the exemplary embodiments can be used in any advantageous combination.

The invention has been described in conjunction with various embodiments herein. However, other variations to the disclosed embodiments can be understood and effected by those skilled in the art in practicing the claimed invention, from a study of the drawings, the disclosure and the appended claims. In the claims, the word “comprising” does not exclude other elements or steps and the indefinite article “a” or “an” does not exclude a plurality. A single processor or other unit may fulfill the functions of several items recited in the claims. The mere fact that certain measures are recited in usually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the internet or other wired or wireless communication systems.

What is claimed is:

1. An electro-optical device, applied in a high-speed passive optical network (HSP-PON), comprising:
an optical signal source, configured to:
generate a modulated optical signal based on non-return-to-zero (NRZ) modulation format, wherein the modulated optical signal comprises at least a first signal level and a second signal level, the first signal level being lower than the second signal level, and wherein an extinction ratio of the modulated optical signal is obtained based on the first signal level and the second signal level; and
output the modulated optical signal, wherein a rate of the modulated optical signal is greater than 10 Gbit/s, and a minimum value of the extinction ratio is 6 dB.

2. The electro-optical device according to claim 1, wherein the optical signal source is a direct modulated laser, a vertical cavity surface emitting laser, or an electro-absorption modulated laser.

3. The electro-optical device according to claim 1, wherein the optical signal source comprises a laser and a modulator,
wherein the laser is configured to generate a continuous laser signal, and
wherein the modulator is configured to modulate the continuous laser signal provided by the laser to obtain the modulated optical signal.

4. The electro-optical device according to claim 1, wherein a required output optical power of the modulated optical signal decreases based on the extinction ratio of the modulated optical signal increasing.

5. The electro-optical device according to claim 1, further comprising an absorber configured to generate an output optical signal from the modulated optical signal, wherein the output optical signal has an extinction ratio larger than the extinction ratio of the modulated optical signal.

6. The electro-optical device according to claim 5, wherein the absorber is further configured to generate the output optical signal from the modulated optical signal by partially absorbing the modulated optical signal.

7. The electro-optical device according to claim 6, wherein the absorber is configured to partially absorb the modulated optical signal with an absorption characteristic, dependent on a present signal level of the modulated optical signal.

8. The electro-optical device according to claim 6, wherein the absorber is configured to partially absorb the modulated optical signal with an absorption characteristic, and
wherein the absorption characteristic defines an absorption factor, which is indirectly proportional to a present signal level of the modulated optical signal.

9. The electro-optical device according to claim 5, wherein the absorber is a semiconductor absorber.

10. The electro-optical device according to claim 9, wherein the absorber is configured so that the modulated optical signal induces, dependent of a present signal level of the modulated optical signal, carriers in the semiconductor absorber.

11. The electro-optical device according to claim 10, wherein the absorber is configured so that, at the second signal level of the modulated optical signal, induction of carriers in the semiconductor absorber reaches saturation, resulting in a weaker absorption of the modulated optical signal at the second signal level than at the first signal level.

12. The electro-optical device according to claim 5, wherein the absorber is only supplied with the modulated optical signal and a power supply signal, and
wherein the power supply signal is a constant signal and/or has a frequency that is smaller, at least by a factor of 10, than a frequency of the modulated optical signal.

13. The electro-optical device according to claim 12, wherein the absorption characteristic is dependent on the power supply signal, and wherein the absorber is configured so that the absorption characteristic is controlled by adapting the power supply signal.

14. The electro-optical device according to claim 13, wherein the electro-optical device further comprises an absorption controller configured to control the absorption characteristic of the absorbe, by controlling the power supply signal provided to the absorber.

15. The electro-optical device according to claim 1, wherein the electro-optical device further comprises an amplifier configured to amplify the modulated optical signal to provide an amplified modulated optical signal.

16. The electro-optical device according to claim 5, further comprising an amplifier configured to amplify the output optical signal to provide an amplified output optical signal, wherein the amplifier is configured to be supplied with power at least in part by the absorber.

17. A transmitter, comprising:
an electro-optical device applied in a high-speed passive optical network (HSP-PON), the electro-optical device comprising:
an optical signal source, configured to:
generate a modulated optical signal based on non-return-to-zero (NRZ) modulation format, wherein the modulated optical signal comprises at least a first signal level and a second signal level, the first signal level being lower than the second signal level, and wherein an extinction ratio of the modulated optical signal is obtained based on the first signal level and the second signal level, and
output the modulated optical signal, wherein a rate of the modulated optical signal is greater than 10 Gbit/s, and a minimum value of the extinction ratio is 6 dB.

18. A signal transmission method applied in high-speed passive optical network (HSP-PON), the signal transmission method comprising:
generating a modulated optical signal based on non-return-to-zero (NRZ) modulation format, wherein the modulated optical signal comprises at least a first signal level and a second signal level, the first signal level being lower than the second signal level, and wherein an extinction ratio of the modulated optical signal is obtained based on the first signal level and the second signal level, and
outputting the modulated optical signal, wherein a rate of the modulated optical signal is greater than 10 Gbit/s, and a minimum value of the extinction ratio is 6 dB.

19. The method according to claim 18, wherein the generating a modulated optical signal based on NRZ modulation format comprises:
generating a continuous laser signal; and
modulating the continuous laser signal based on the NRZ modulation format to obtain the modulated optical signal.

20. The method according to claim 18, wherein the required output optical power of the modulated optical signal decreases based on the extinction ratio of the modulated optical signal increasing.
